(19) United States
(12) Patent Application Publication
(10) Pub. No.: US 2003/0032360 A1
(43) Pub. Date: Feb. 13, 2003

(54) Nonwoven fabric containing fibers made of polyoxyalkylene, method for their production and use

(75) Inventor: Peter Kritzer, Forst (DE)

Correspondence Address: KENYON & KENYON, ONE BROADWAY, NEW YORK, NY, 10004, US

(73) Assignee: Carl Freudenberg KG

(21) Appl. No.: 10/205,212

(22) Filed: Jul. 25, 2002

(30) Foreign Application Priority Data
Aug. 11, 2001 (DE) 101 39 640.6

(51) Int. Cl. D02G 3/00; B32B 1/00; D04H 1/00; D04H 3/00

(52) U.S. Cl. 442/414; 442/415; 428/219; 428/365; 428/359; 428/364

(57) ABSTRACT

A nonwoven fabric containing fibers made of polyoxyalkylene and a method for its production and its use. The fabric may be obtained by known methods of producing nonwovens and may particularly be used as a separator in batteries.

### BACKGROUND OF THE INVENTION

1. Field of the Invention

The invention relates to nonwoven fabrics containing fibers made of polyoxyalkylene, as well as to their production and use, especially for producing separators for rechargeable alkaline batteries.

2. Description of Related Art

Polyacetate copolymer (also called “polyoxymethylene” or “POM”) is a polymer that has been commercially available since the 1960's. Examples of this are the products “Hostaform” (Ticona GmbH), “Ultraform” (BASF AG) or “Sniatal” (Rhodia). The material is mainly used as injection molding material, for example, in the automobile industry. Its resistance to chemicals such as alkaline media and organic solvents is excellent.

Making monofilaments of this material has been described (cf, for instance, U.S. Pat. No. 4,060,582; GB-A-1,439,886; and FR-A-1,473,682).

The possibility of making fibers from this material is also known (cf, for instance, JP-A-51/26,322; FR-A-1,584,083; DE-A-1,947,430; GB-A-1,449,581).

So far, nonwoven fabrics containing fibers of this material have not been described in the literature.

In environments in which chemically aggressive materials are present, for example in batteries, the usual nonwoven fabrics may not be usable without further consideration. Nonwoven fabrics are used in rechargeable alkaline batteries as separators.

These separators separate the two differently charged electrodes in the accumulator storage battery and thus prevent an inner short-circuit. A number of requirements are made on separator materials, which may be summarized as follows: Resistance to electrolytes, resistance to oxidation, low resistance to ion passage, high resistance to electron passage, permanent wettability by the electrolyte, high storage capacity for the electrolyte, capability of retention of particles detached from the electrodes, low thickness tolerances and great mechanical stability.

Separator materials that have been used up to this point for rechargeable alkaline battery types must overcome two problems. On the one hand, they should prevent the self-discharge of these cells or should at least not support it to any extent, and on the other hand, they must have a permanent “basic” wettability for the electrolyte.

The literature describes ammonia as being responsible for the self-discharge of rechargeable alkaline battery types. It may be liberated as a contaminant in the active materials of the electrodes or on account of decomposition of nitrogen-containing separator materials (such as ones based on polyamide).

Ammonia may be oxidized to nitrite or nitrate at the anode, and these in turn are reduced again at the cathode, so that a “discharge circuit” (the so-called “nitrate ammonia shuttle”) is created. This phenomenon, which appears even when the cells are idle, is especially pronounced in nickel/metal hydride cells, where, on account of the presence of H radicals at the cathode, the otherwise slow reduction of nitrite/nitrate may run greatly speeded up. This self-discharge is still the greatest problem with nickel/metal hydride cells.

Self-discharge is also important with nickel/cadmium batteries.

Polyamide nonwoven fabrics are subject to noticeable decomposition in strongly alkaline electrolytes, in which ammonia ia liberated. For that reason, their use is limited almost exclusively to nickel/cadmium batteries.

Therefore, for metal/hydride cells, separators based on polyolefin are used almost exclusively at this time. These are chemically stable to the electrolyte (30% KOH; T up to about 70° C.). However, their wettability is very low, on account of their nonpolar surface. A lack of wettability, in turn, can lead to two decisive problems. On the one hand, the initial wettability is low when the battery is filled during production. This leads to the problem that either only a diminished amount of electrolyte can be added (and thereby the cell's capacity is limited) or that production time becomes decidedly longer (which makes the production process more costly). On the other hand, the lack of durable wettability during operation can cause the battery to “run dry”, and thus malfunction, or its life cycle is reduced.

In order to increase the polarity of separator materials based on olefins, therefore, these separators are currently submitted to further production steps, such as a partial gas-phase fluorination or chemical impregnation.

A reduction of self-discharge, caused by the above-named contamination of the active material of the electrodes, is currently achieved by grafting of ammonia-binding substances, such as acrylic acid or sulfuric acid, in which the kind of activation of the surface plays a decisive role. Both methods require much effort and are therefore cost-intensive, and in the latter case should be viewed as critical, from the point of view of work safety and environmental factors, because of the use of highly concentrated sulfuric acid.

### SUMMARY OF THE INVENTION

In accordance with the invention, there is provided a nonwoven fabric containing fibers made of polyoxyalkylene, preferably polyoxymethylene (POM). The invention makes available a nonwoven fabric which, compared to the polyamides, has a substantially higher resistance to chemically aggressive compounds such as appear in the strongly alkaline electrolytes of rechargeable batteries, and, as a result, is submitted to a clearly lesser decomposition. In addition, it has turned out that the potential decomposition products do not foster the self-discharge of nickel/metal hydride cells, for example.

### DETAILED DESCRIPTION OF THE INVENTION

Compared to polyolefins, POM has higher “base hydrophilic” properties because of the oxygen atoms present in its molecules, so that subsequent treatments such as gas-phase fluorination may be omitted for certain applications. It is also ensured that, because of the chemical resistance of the nonwoven fabric material, these basic hydrophilic properties are not lost during use, which may happen in principle in a subsequent chemical surface treatment (e.g. during impregnating, where the applied substances are not chemically linked to the surface).

Unfinished and fluorinated separator nonwoven fabrics do not have the property of binding ammonia (the rate of titrimetrically determined so-called “ammonia trapping” has values lower than 0.05×10⁻⁴ mol NH₃ per gram of separator material. “Very good” separator materials, however, have values of about 2-3×10⁻⁴ mol NH₃ per gram).

Furthermore, it has recently been found that the nonwoven fabric according to the present invention has good values of 0.5×10⁻⁴ mol NH3 per gram. This means that here, under certain circumstances, one may do without a costly finishing or retreatment, because of the good ammonia binding capacity that is present.

The present invention relates to a nonwoven fabric containing fibers made of polyoxyalkylene, preferably polyoxymethylene.

The nonwoven fabric according to the present invention may be made of any fiber type of the most varied titer ranges, for instance, a titer of 0.5 to 5 dtex. Besides continuous filaments, those nonwoven fabrics may be made of short-cut fibers, or may contain them.

Besides homofil fibers, heterofil fibers or mixtures of the most varied fiber types may be used, as long as at least one of these fiber types is made of polyoxyalkylene or at least contains polyoxyalkylene (e.g. in the case of skincore fibers).

The nonwoven fabric according to the invention may be produced by any methods known per se in a wet or dry manner, for example, by a spunbonding method, by carding, by a blow mold method or by a wet laid nonwoven method.

In the case of the use of polyoxyalkylene according to the invention, a polymer is involved that has the recurring structural unit of formula (1)

—(CₙH₂ₙ—O)— (1)

where n is a whole number from 1 to 4, preferably 1 and/or 2.

In addition to polyoxyalkylene homopolymers, copolymers containing the recurring structural unit of formula 1 and further recurring structural units derived from comonomers may also be used.

Examples of copolymers are polyoxyalkylene copolymers containing the recurring structural units of formula 1, where n=1 denotes (polyoxymethylene) and where n=2 denotes (polyoxyethylene). Such POM copolymers are derived from trioxan (n=1) and dioxolane (n=2).

Typically, the nonwoven fabrics according to the present invention have a mass per unit area of 5 to 500 g/m².

Nonwoven fabrics having low mass per unit area of 5 to 150 g/m² are preferably used.

A preferred specific embodiment of the present invention relates to nonwoven fabrics made of a combination of polyoxyalkylene fibers, especially of the copolymers described as preferred above, with polyamide fibers, or of polyoxyalkylene fibers, especially of the copolymers described as preferred above, with polyolefin fibers. Other preferred polymers, which may be used in the form of fibers together with the polyoxyalkylene fibers, are polyphenylsulfide, polysulphone and polytetrafluoroethylene.

Another preferred specific embodiment of the present invention relates to nonwoven fabrics containing polyoxyalkylene fibers which have been treated with compounds imparting hydrophilic properties or raising hydrophilic properties. Compared to the non-treated types, these nonwoven fabrics display even greater basic hydrophilic properties.

Examples for such finishing treatments are known per se. These may involve surface treatment, such as fluorinating, chemical impregnation, corona or plasma treatment, grafting with unsaturated carboxylic acids or sulphonation. These methods are used for the further improvement of the hydrophilic properties or for reducing self-discharge.

Combinations of polyamide and polyalkylene fibers are especially preferred. Such nonwoven fabrics are particularly good for use as separators for Ni/Cd cells. Such combinations have the essentially undiminished and great hydrophilic properties of polyamide separators, as well as a chemical resistance comparable to that of polyamide/polyolefin combinations.

In the case of the likewise preferred combinations of polyolefin and polyoxyalkylene fibers it has been shown that these have good binding properties for ammonia, and are thus preferably used, for instance, in nickel/metal hydride cells. In addition, such a combination has better hydrophilic properties than pure polyolefin nonwoven fabrics. Such combinations can be produced substantially more economically than nonwoven fabrics made of finish-treated polyolefins.

The invention also relates to a method for producing the nonwoven fabrics described above, including the following steps:

a) production of fiber made of polyoxyalkylene homopolymers or copolymers in a method known per se, and

b) formation of a nonwoven fabric in a method known per se.

The nonwoven fabrics according to the present invention may be used in environments in which chemically aggressive materials are present. Examples of this are the use as filter materials or as separators in batteries, especially in batteries having alkaline electrolytes. These applications are also the subject matter of the present invention.

### EXAMPLES

The following examples describe the present invention without limiting it.

Using an installation described in DE-A4,301,373, fibers were spun from the commercially available polymer “Hostaform C52021” (Ticona GmbH). Before that, the polymer was first dried for eight hours at 120° C. The spinning temperature was 215° C. Fiber lengths between 5 mm and several centimeters could be achieved, which were processed to dry-laid nonwovens and wet-laid nonwovens.

For the dry-laid nonwovens, staple fibers of fiber length 40 mm and titers of 3 dtex were used. From these, 50 cm-wide nonwoven fabrics having a mass per unit area of 50 g/m² were produced on an installation at a technical college. The bonding was carried out by spot bonding. Alternatively, a nonwoven fabric having a fiber proportion of 25% of a propylene/polyethylene bicomponent fiber was produced, and it was bonded thermally at 120-130° C.

The wet-laid nonwoven was produced on a sheet-forming installation, using short-cut fibers (fiber length 5 mm). The mass per unit area arrived at was 50 g/m².

To ascertain the resistance to chemicals, the following experiments were conducted:

1) Aging of pure POM nonwoven fabrics in 30% KOH solution at 70° C. for a time period of 7 days. A mass loss of less than 0.5% was found.

2) Aging of pure POM nonwoven fabrics in KMnO₄ solution at 50° C. for a time period of 24 hours. Thae mass loss was roughly 2%.

Both values correspond to the ones of usual separator materials.

For the purpose of ascertaining ammonia absorption capacity, the nonwoven fabric was aged in a 0.3 molar alkaline ammonia solution at 40° C. for 3 days. The ammonia remainder was determined titrimetrically. For this purpose, three samples of approximately 5 g of the fibers or the nonwoven fabric were aged in 120 ml of an 8-molar KOH solution with the addition of 5 ml of 0.3 molar NH₃ solution at T=40° C. for a time period of 3 days. Simultaneously, 3 blank tests were prepared without material to be tested.

After storage, an aliquot of 100 ml was withdrawn and the NH₃ was transferred by steam distillation into a receiving flask holding 150 ml of distilled water which contained 10 ml of 0.1 molar HCl and a few drops of methyl red as indicator. The acid was titrated back with NaOH.

The ammonia absorption capacity had a value of around 0.5×10⁻⁴ mol NH₃ per gram.

What is claimed is:

1. A nonwoven fabric comprising fibers made of polyoxyalkylene.

2. The nonwoven fabric according to claim 1, wherein the polyoxyalkylene is a polymer which has the recurring structural unit of formula (1)
—(CₙH₂ₙ—O)— (1)
where n is a whole number from 1 through 4.

3. The nonwoven fabric according to claim 2, wherein n is 1 or 2.

4. The nonwoven fabric according to claim 1, wherein the fibers have titers of 0.1 through 30 dtex.

5. The nonwoven fabric according to claim 2, wherein the fibers have titers of 0.1 through 30 dtex.

6. The nonwoven fabric according to claim 1, wherein the fibers are continuous filaments.

7. The nonwoven fabric according to claim 2, wherein the fibers are continuous filaments.

8. The nonwoven fabric according to claim 4, wherein the fibers are continuous filaments.

9. The nonwoven fabric according to claim 1, wherein the fibers are short-cut fibers.

10. The nonwoven fabric according to claim 2, wherein the fibers are staple fibers.

11. The nonwoven fabric according to claim 4, wherein the fibers are staple fibers.

12. The nonwoven fabric according to claim 1, wherein the fabric has a mass per unit area of 5 through 500 g/m².

13. The nonwoven fabric according to claim 2, wherein the fabric has a mass per unit area of 5 through 500 g/m².

14. The nonwoven fabric according to claim 1, further comprising polyamide fibers in addition to the polyoxyalkylene fibers.

15. The nonwoven fabric according to claim 1, further comprising polyolefin fibers in addition to the polyoxyalkylene fibers.

16. The nonwoven fabric according to claim 1, wherein the polyoxyalkylene fibers have hydrophilic properties.

17. A method for producing the nonwoven fabric according to claim 1, comprising:
a) producing fibers of polyoxyalkylene homopolymers or copolymers, and
b) forming a nonwoven fabric therefrom.

18. A filtering material comprising the nonwoven fabric according to claim 1.

19. A separator for a battery having alkaline electrolytes comprising the nonwoven fabric according to claim 1.
